(19) United States
(12) Patent Application Publication
(10) Pub. No.: US 2006/0083004 A1
(43) Pub. Date: Apr. 20, 2006

(54) Flat-panel area illumination system

(75) Inventor: Ronald S. Cok, Rochester, NY (US)

Correspondence Address: Paul A. Leipold;Patent Legal Staff, Eastman Kodak Company, 343 State Street, Rochester, NY, 14650-2201, US

(73) Assignee: Eastman Kodak Company

(21) Appl. No.: 10/966,210

(22) Filed: Oct. 15, 2004

(51) Int. Cl. F21V 5/02; F21V 9/16

(52) U.S. Cl. 362/330; 362/84; 362/331; 362/339

(57) ABSTRACT

A flat-panel area illumination system is described, comprising: a) a flat-panel lamp having a substrate and one or more non-pixellated light-emitting areas formed on the substrate emitting light in every direction from at least one light-emitting side of the lamp; and b) a light-directing optical film located on the at least one light-emitting side over the light-emitting area of the flat-panel lamp, wherein the light-directing optical film preferentially directs light away from a direction perpendicular to the surface of the light-emitting side of the flat-panel lamp. The flat-panel lamp system of the present invention provides light direction capability for a flat-panel OLED lamp while preserving a thin profile.

### FIELD OF THE INVENTION

This invention relates to illumination provided by flat-panel lamps and, in particular, to means for directing the light from a flat-panel lamp.

### BACKGROUND OF THE INVENTION

Flat-panel light sources are a new illumination technology and are notable for their form factor and area light emission. Such lamps are typically relatively thin, for example a few millimeters thick, and emit light over most of the lamp's surface. The light is typically emitted in every direction from the surface of the lamp. However, in many applications, it is preferred that light be preferentially directed, for example toward a wall, ceiling, or floor.

Existing commercially available lighting sources such as incandescent and fluorescent bulbs typically rely upon a lighting fixture that is used to direct the light. Such lamps typically emit light from a limited area, such as a filament, cylindrical bulb, or solid-state light emitting diode (LED) and must be very bright to provide adequate illumination. Hence, light-directing shades are necessary to provide a pleasing environment without glare. For example, incandescent desk or floor lamps usually have a shade that directs the light up toward the ceiling and down toward the floor. Wall sconces typically direct their light along a wall. Ceiling lamps often provide directed spot or task lighting, or include reflectors that direct light horizontally toward a wall. Such lamps are bulky, especially when combined with shades or reflectors. The choice of light direction is dependent upon the application and location of a lamp, as well as the technology used to provide the illumination.

Although not prevalent, flat-panel lamps are known in the industry and may employ organic light emitting diodes to provide light. For example, U.S. 20040061439 A1 entitled “OLED Lamp” by Cok published Apr. 1, 2004 describes an OLED lamp that includes a substrate; a non-pixellated OLED formed on the substrate, the OLED including a first electrode formed on the substrate and extending from a first edge of the substrate toward a second opposite edge of the substrate, an OLED light emitting structure formed on top of the first electrode, leaving exposed a portion of the first electrode near the first edge of the substrate, and a second electrode formed over the OLED light emitting structure and extending to the second edge of the substrate; and an encapsulating cover located over the non-pixellated OLED leaving exposed portions of the first electrode and the second electrode for making electrical contact to the lamp. Such OLED lamps may include fixtures, have rigid or flexible substrates, and may include lamp shades, for example as taught in U.S. 20030222559 A1 entitled “Lighting apparatus with flexible OLED area illumination light source and fixture” by the same author and published Dec. 4, 2003.

A simplified illustration of such prior-art OLED flat-panel lamps is shown in FIG. 20. Referring to FIG. 20, a flat-panel lamp 12 includes a substrate 100 on which is deposited a first electrode 102, one or more organic layers 104 and a second electrode 106. The flat-panel lamp 12 is encapsulated with a cover 110. Upon the application of a voltage across the electrodes 102 and 106, current flows through the organic layer(s) 104 to produce light that is emitted through either the substrate 100 or cover 110, depending on the design of the device. The light emitting area is defined by the extent of the electrodes and organic layer(s) 102, 104, and 106 over the substrate 100. Referring to FIG. 2, the light 30 emitted is emitted approximately equally in every direction from the entire light-emitting surface of the lamp 12. The lengths of the arrows representing light rays in FIG. 2 are approximately equal and graphically illustrate that the amount of light emitted in the direction of the arrows is approximately equal. Although these lamps emit light over a much greater area than do conventional lamps, they can still be very bright and may require shading. Moreover, some lighting designs can require that the emitted light be directed in particular directions.

Optical films, including brightness enhancement films and light turning films, are described, e.g., in U.S. Pat. Nos. 6,707,611, 6,752,505, 6,760,157. Such films are typically employed to collimate or diffuse light in various applications, e.g. in LCD device backlights having side or back illumination with fluorescent or point-source LED emitters.

As described in the prior art, flat-panel lamps do not maintain a flat and thin configuration when coupled with a light-directing element, for example a shade or other fixture. There is a need therefore for an improved flat-panel area illumination system that overcomes this objection while providing directed lighting.

### SUMMARY OF THE INVENTION

The need is met in accordance with one embodiment of the invention by providing a flat-panel area illumination system, comprising: a) a flat-panel lamp having a substrate and one or more non-pixellated light-emitting areas formed on the substrate emitting light in every direction from at least one light-emitting side of the lamp; and b) a light-directing optical film located on the at least one light-emitting side over the light-emitting area of the flat-panel lamp, wherein the light-directing optical film preferentially directs light away from a direction perpendicular to the surface of the light-emitting side of the flat-panel lamp.

### ADVANTAGES

The flat-panel lamp system of the present invention provides light direction capability for a flat-panel OLED lamp while preserving a thin profile.

### BRIEF DESCRIPTION OF THE DRAWINGS

FIG. 1a is a schematic diagram showing a flat-panel area illumination system according to one embodiment of the present invention;

FIG. 1b is a schematic diagram showing a flat-panel area illumination system according to another embodiment of the present invention;

FIG. 2 is a prior-art schematic diagram of a flat-panel lamp;

FIG. 3 is a perspective view of a light-directing optical film according to one embodiment of the present invention;

FIG. 4 is a schematic diagram showing a flat-panel area illumination system according to an alternative embodiment of the present invention;

FIGS. 5a-b are perspective views of light directing structures;

FIGS. 6a-d are micrograph views of light directing structures;

FIG. 7 is a schematic diagram illustrating the light output from the embodiment of FIG. 1a;

FIG. 8 is a schematic diagram showing a flat-panel area illumination system and light output according to another alternative embodiment of the present invention;

FIG. 9 is a schematic diagram showing a flat-panel area illumination system having multiple light-directing optical films according to another alternative embodiment of the present invention;

FIG. 10 is a top view of a light-directing optical film according to an embodiment of the present invention;

FIG. 11 is a top view of a light-directing optical film according to another alternative embodiment of the present invention;

FIG. 12 is a top view of a light-directing optical film according to yet another alternative embodiment of the present invention;

FIG. 13 is a graph illustrating the light output of an OLED flat-panel lamp;

FIG. 14 is a graph illustrating the light output of a flat-panel area illumination system according to the embodiment of FIG. 1a;

FIG. 15 is a graph illustrating the light output of a flat-panel area illumination system according to the embodiment of FIG. 9;

FIG. 16 is a graph illustrating the light output of an other OLED flat-panel lamp;

FIG. 17 is a schematic diagram showing a flat-panel area illumination system according to the alternative embodiment of FIGS. 6a-6b;

FIG. 18 is a schematic diagram showing a flat-panel area illumination system according to the alternative embodiment of FIGS. 6c-6d;

FIG. 19 is a schematic diagram showing a flat-panel area illumination system including a diffuser according to an alternative embodiment of the present invention; and

FIG. 20 is a schematic diagram of a prior-art OLED flat-panel lamp.

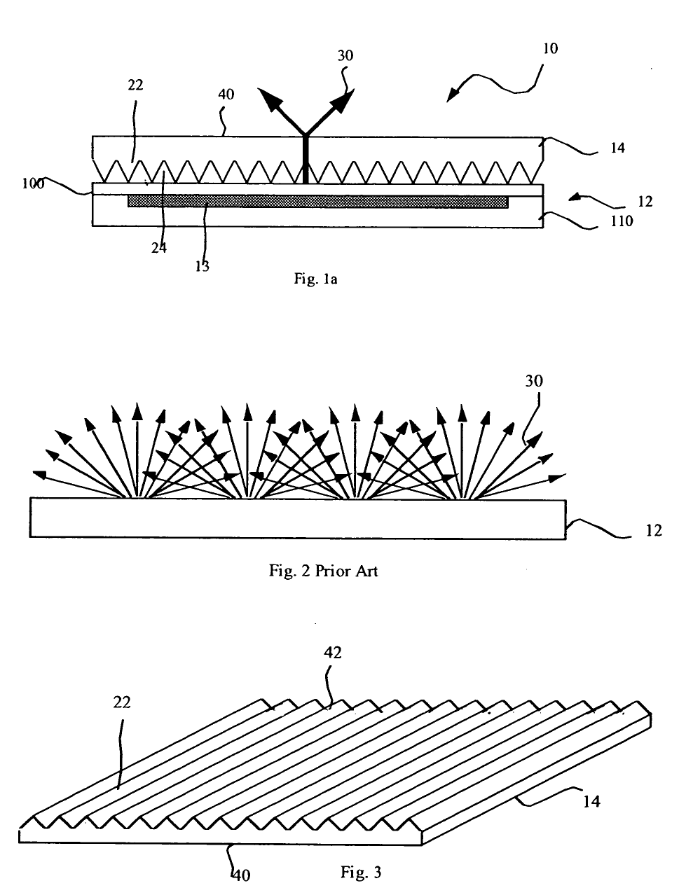

### DETAILED DESCRIPTION OF THE INVENTION

Referring to FIG. 1a, a flat-panel area illumination system 10, comprises a flat-panel lamp 12 having a substrate with one or more non-pixellated light-emitting areas 13 formed on the substrate and emitting light 30 in every direction from at least one side of the lamp 12; and a light-directing optical film 14 located over the light emitting area 13 of the flat-panel lamp. The light-directing optical film 14 of FIG. 1 is shown in a perspective view in FIG. 3. Referring to FIG. 3, the light-directing optical film 14 includes a flat surface 40 on one side and a structured surface 42 on the other side of the light-directing optical film 14.

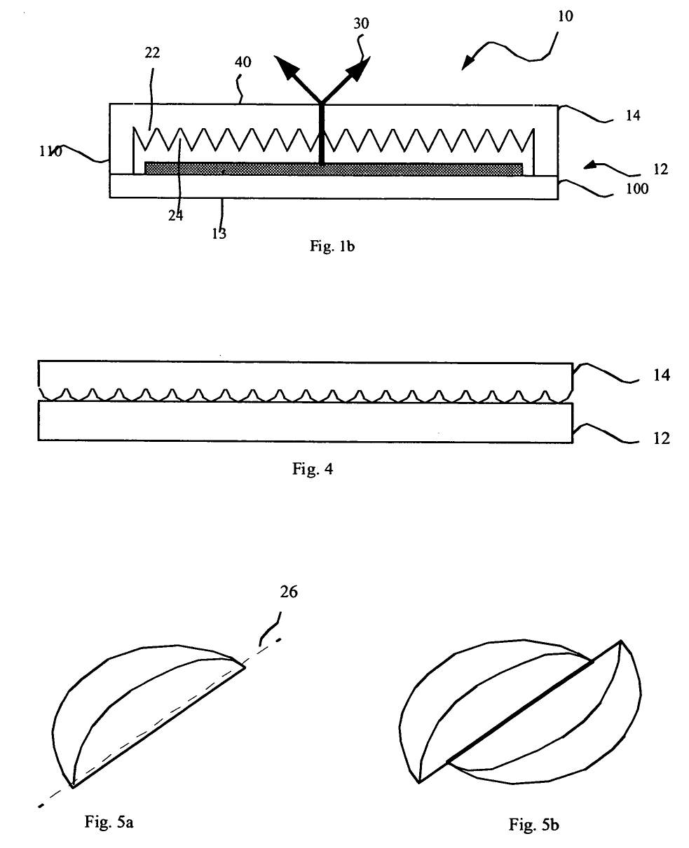

The structures 22 formed on the structured surface 42 can take a variety of shapes, for example regular triangular prisms or cylindrical lenses (shown in FIGS. 3 and 4) formed in adjacent rows, such as are described in U.S. Pat. Nos. 6,707,611, 6,752,505, 6,760,157. The structures 22 are much smaller than the light-emitting area 13 so that a plurality of structures is associated with each light-emitting area. The light-directing optical film 14 may be either rigid or flexible and may be made of, for example, plastic such as PET or glass, and can be constructed using a variety of techniques known in the art, for example injection roll molding and embossing. A variety of shapes and structural relationships are possible, for example the shapes of the structures may be different, may have different sizes or have portions that intersect at different angles, and may have pointed or rounded peaks or cavities.

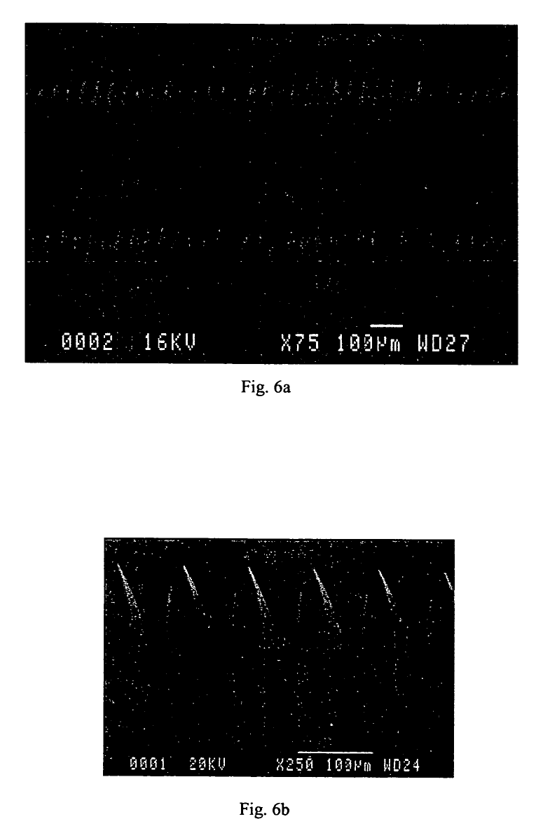

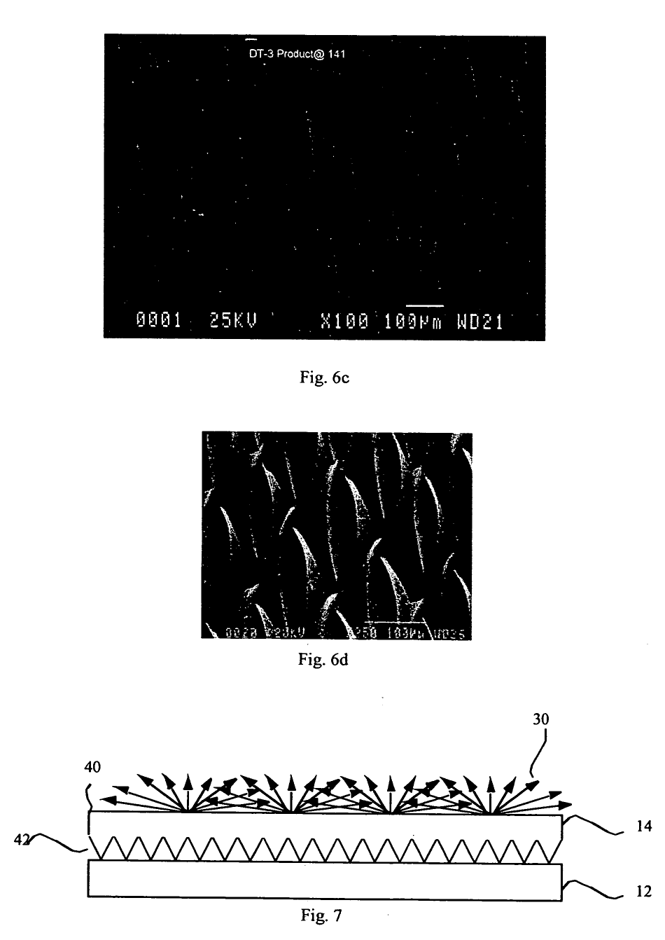

Referring to FIG. 5a, in an alternative embodiment, the structures can be wedge shaped and have a long axis 26 and in which the axes of the wedge-shaped structures are aligned in a common direction. The wedge can have a curved outside edge or may have an extensive straight portion with curves on the ends. Referring to FIG. 5b, the wedges may be formed in facing pairs. Referring to FIGS. 6a and 6b, for example in photomicrographs of an alternative embodiment implemented by applicant, the wedge pairs are aligned in rows having axes formed into parallel lines. Referring to FIGS. 6c and 6d, in photomicrographs of another alternative embodiment, the wedges have parallel axes but are not formed into lines and are randomly located in one dimension while they are aligned in another.

The structures 22 formed on the structured surface 42 of the light-directing optical film 14 are much smaller than the light-emitting areas 13 of the flat-panel lamp 12, the structures serve to re-direct the light from the flat-panel lamp 12 rather than to focus the light in an image-wise fashion. The actual shape of the structures defines the nature of the light re-direction. The light-directing optical display film 14 and structures 22 are formed from a relatively high refractive index material compared to the gaps 24 formed between the structures. The gaps 24 may be, for example, air or a lower refractive index material.

The flat-panel area illumination system 10 may emit light through the substrate and the optical film may be located over the substrate (as shown in FIG. 1a). In an alternative embodiment of the present invention (shown in FIG. 1b), the flat-panel area illumination system 10 may further comprise an encapsulating cover over the light emitting area and affixed to the substrate and may emit light through the cover. In this embodiment, the optical film is located over the cover or is formed in the cover (as in FIG. 1b).

The flat-panel lamp 12 may be an OLED lamp. Such a lamp may emit light from one or both sides, may be flexible or rigid and may be a bottom- or top-emitting device, as is known in the art. FIG. 1a illustrates a bottom-emitting embodiment while FIG. 1b illustrates a top-emitting embodiment.

In accordance with the invention, the light-directing optical film preferentially directs light away from a direction perpendicular to the surface of the light-emitting side of the flat-panel lamp. Referring to FIG. 7, in one embodiment of the present invention, such effect may be realized by employing the structured side 42 of the light-directing optical film 14 adjacent to the light-emitting side of the flat-panel lamp 12, so that the structured side of the light-directing optical film receives the light emitted by the flat-panel lamp. In this configuration, the light-directing optical film 14 will direct an increased amount of light 30 away from a perpendicular to the surface of the flat-panel lamp and film. The length of each light 30 ray indicates the amount of light emitted in the direction of the ray. A shorter ray indicates that less light is emitted in that direction; a longer ray indicates that more light is emitted in that direction. This is in contrast to prior art uses of brightness enhancing and light-directing films such as described in, e.g., U.S. Pat. Nos. 6,707,611, 6,752,505, 6,760,157, wherein structures are typically employed to collimate or diffuse light in various applications and are employed on the light-exiting side of the film. The present invention may be particularly useful, for example, in a flat-panel ceiling illumination system where it is desired to reduce glare from the lamps by directing the light along the ceiling toward the walls where it can be diffusely reflected into a room or hallway. The light-directing optical film may be affixed to the flat-panel lamp by adhesives applied to the peaks of the structures or around the edges of the lamp or at specific locations within the light-emitting areas of the lamp.

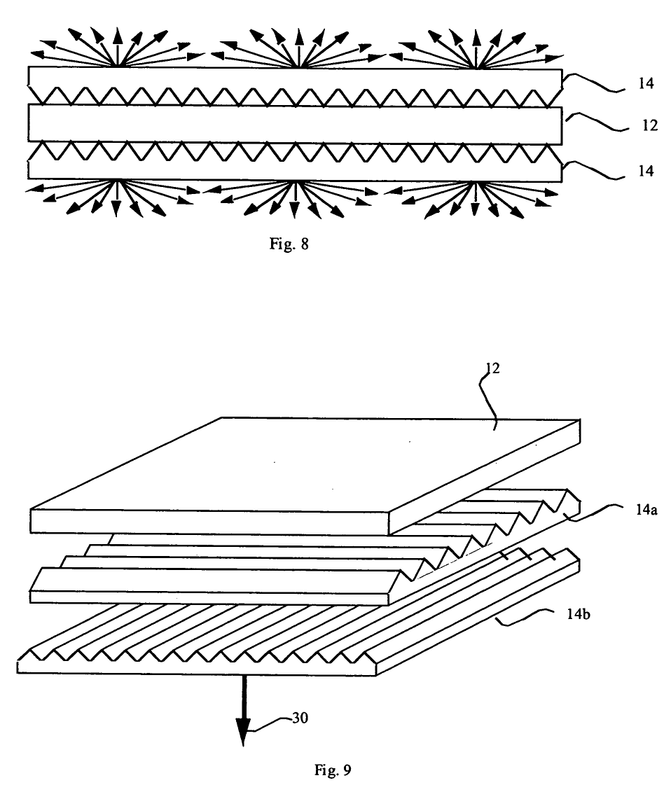

In an alternative embodiment illustrated in FIG. 8, a flat-panel lamp may emit light from both sides and a light-directing optical film provided on both sides of the flat-panel lamp. This arrangement is useful in a light suspended from a ceiling and efficiently providing light primarily directed to the sides. Alternatively, the films provided on each side may be different, for example the film on one side may direct light away from a normal while the film on the other side may direct light toward a normal.

A single light-directing optical film is limited in its ability to direct light. By using a combination of films oriented in different directions, a wider variety of light-directing modalities may be obtained. For example, referring to FIG. 9, a flat-panel lamp 12 may further include a second light-directing optical film 14b located over the light directing optical film 14a and parallel to the light-directing optical film 14a and wherein the structures of the second light-directing optical film 14b are at an angle, for example 90 degrees, to the structures of the light-directing optical film 14a. Additional light-directing optical films with structures oriented at different angles, for example multiples of 60, 45 or 30 degrees, may be stacked to provide a wider variety of light-direction modalities.

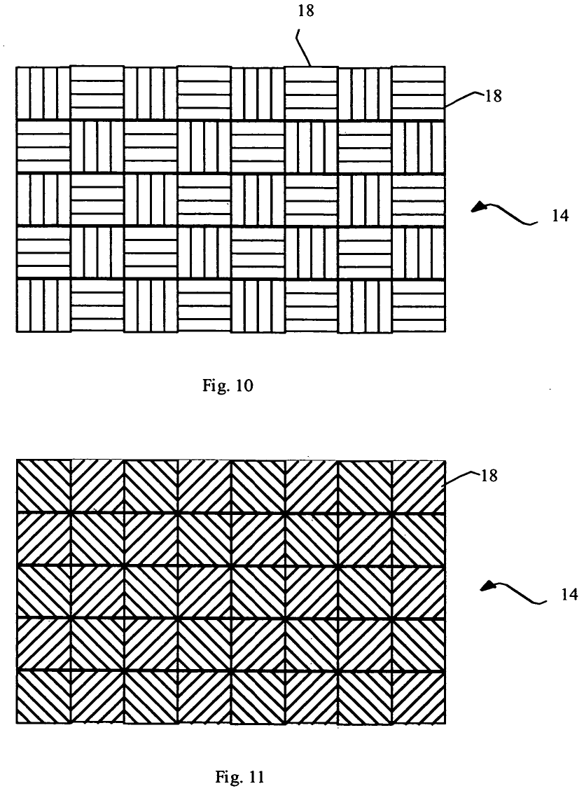

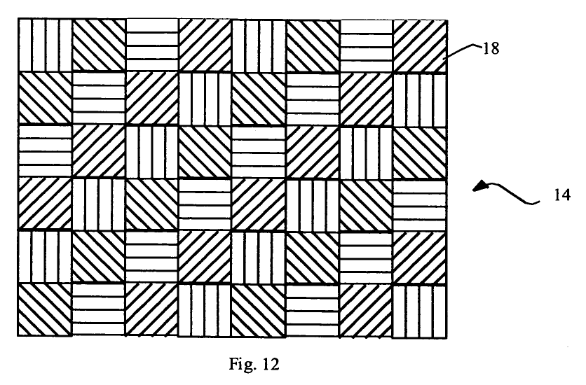

This design, while useful, has the limitation of requiring multiple films stacked over each other, increasing costs and thickness. Moreover, optical films are not perfectly clear, so that some light will be absorbed in the film, reducing the efficiency of the illumination system. Referring to FIG. 10, in an alternative embodiment of the present invention, a single light-directing optical film 14 is divided into a plurality of regions 18 and the structures in one region are oriented at a different angle from the structures in a second region. As shown in FIG. 10, the regions 18 are of two types, each type has similar structures oriented perpendicularly to the other. Each region 18 of the light-directing optical film 14 will direct light in its preferred direction. Overall, if the regions 18 are relatively small compared to the light-emitting area 13, the light-directing properties of the regions 18 are combined. As illustrated in FIG. 10, the structures are parallel or perpendicular to the edges of the optical film. In an alternative arrangement shown in FIG. 11, the structures are at another angle with respect to the edges of the light-directing optical film and may be constructed to suit a particular application. The number of types of regions 18 is not limited to two. Referring to FIG. 12, four different light-directing regions 18 have their structures relatively oriented at 0, 45, 90, and 135 degrees to provide an emissive profile that combines the light from each region 18. If it is .desired to reduce the perceptibility of light directed by the different regions, the regions may be made small relative to the size of the flat-panel lamp and the different regions 18 may alternate over the extent of the light emitting area 30 of the flat-panel lamp 12.

The flat-panel lamp 12 and light-directing optical film 14 comprising the illumination system of the present invention may be manufactured separately. Once manufactured, the flat-panel lamp 12 and light-directing optical film 14 may be combined, typically by adhering the film to the lamp to form a single, flat-panel device. Once integrated, the flat-panel lamp may be illuminated to provide a flat-panel area illumination system emitting light in preferred directions. Note that care must be taken to orient the system at installation to ensure that the illumination system performs as desired within a specific illuminated space. In one suitable manufacturing process, the flat-panel lamp and the light-directing optical film may be formed from a web in a continuous roll.

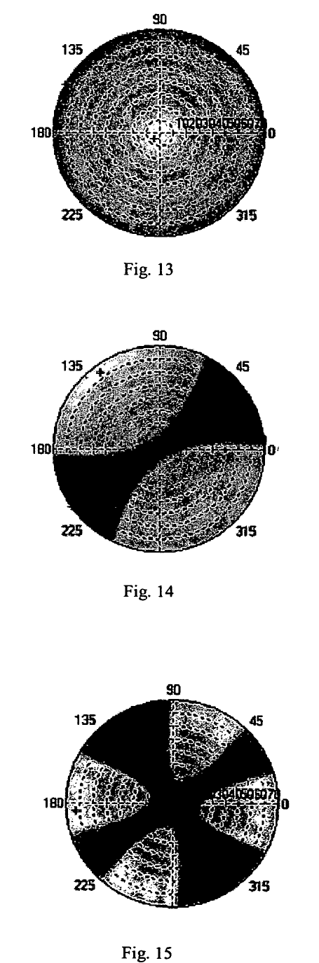

Referring to FIGS. 13-15, the performance of the light-directing optical film and flat-panel lamp illustrated in FIG. 1a is measured. The circular graphs show the relative brightness of the illumination system over a hemisphere, so that, for example, the central point of the circle shows the amount of light emitted perpendicular to the surface of the lamp and the edges of the circle shows the amount of light emitted horizontal to the surface of the lamp and in the relative direction indicated from the center point. The lightness of the point indicates the brightness of the light; dark areas of the graph indicate that relatively little light is emitted in the corresponding direction.

FIG. 13 illustrates the output of an OLED flat-panel lamp with no light-directing optical film. As can be seen from this graph, the light emitted from the lamp is relatively isotropic and has no preferred direction that is, the light emitted is substantially Lambertian; an approximately equal amount of light is emitted in every direction from every point of the light emitting surface area. In this experiment, e.g., the amount of light emitted perpendicular to the substrate is less than twice that emitted in any other direction. Referring to FIG. 14, the light output from the configuration of FIGS. 1a and 7 is illustrated, employing a film having triangular prisms as illustrated in FIG. 3. As can be seen from FIG. 14, the light is preferentially directed to the sides. Relatively little light is emitted straight downwards or in the direction of the structures. In this experiment, the amount of light emitted in the preferential direction is more than a factor of ten greater than the amount of light emitted in the least preferential direction. Referring to FIG. 15, the performance of the configuration of FIG. 9 is indicated, demonstrating that a combination of separate films can effectively direct light in preferred directions, with differential performance in multiple directions.

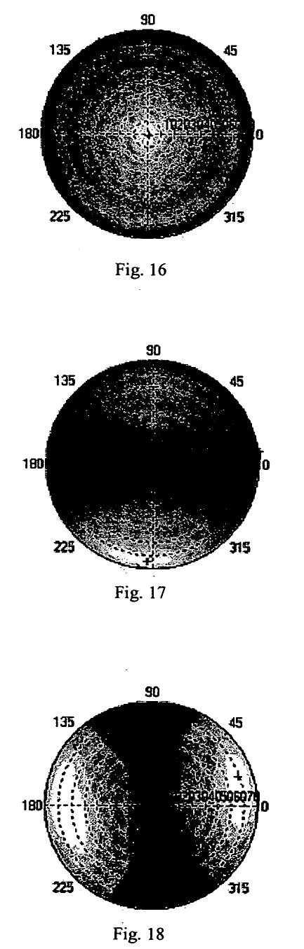

FIGS. 16-18 illustrate the effect of light-directing optical films having wedge structures as shown in FIGS. 6a-6d. FIG. 16 shows the performance of a second OLED flat-panel lamp with no film. Similarly as in FIG. 13, the amount of light emitted perpendicular to the substrate is less than twice that emitted in any other direction. FIG. 17 shows the performance of the same lamp with a film having wedge structures as illustrated in FIGS. 6a and 6b. The performance of a film having wedge structures as illustrated in FIGS. 6c and 6d is similarly shown in FIG. 18. As can be seen from FIGS. 17 and 18, the light is in each instance preferentially directed to the sides. Relatively little light is emitted straight downwards or in the long axis direction of the wedge structures. In these experiments, the amount of light emitted in the preferential direction is more than a factor of five greater than the amount of light emitted in the least preferential direction.

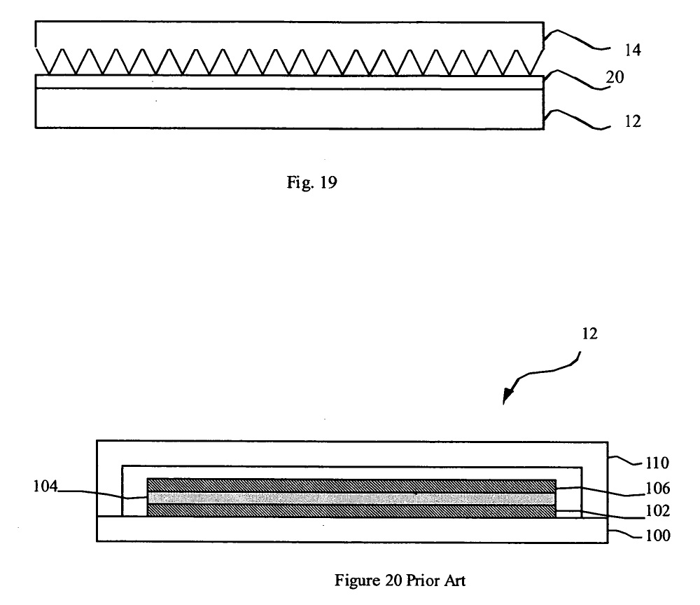

The flat-panel area illumination system of the present invention may also include a diffuser located between the light-directing optical film and the flat-panel lamp (FIG. 19). Such diffusers may be useful in reducing any angular dependence on color that may be found in the light emitted from the flat-panel lamp chromaticity, may reduce the appearance of non-uniformities in the light emitted from the lamp, or may improve the amount of light emitted from the flat-panel lamp.

The present invention may be used in conjunction with any flat panel lamp, including but not limited to OLED lamps.

The entire contents of the patents and other publications referred to in this specification are incorporated herein by reference.

The invention has been described in detail with particular reference to certain preferred embodiments thereof, but it will be understood that variations and modifications can be effected within the spirit and scope of the invention.

### Parts List

10 flat-panel lighting system

12 flat-panel lamp

13 light-emitting area

14 light-directing optical film

14a light-directing optical film

14b light-directing optical film

18 region of light-directing optical film

20 diffuser

22 high refractive index material structures

24 low refractive index material gaps

26 axis

30 light

40 flat side

42 structured side

100 substrate

102 electrode

104 organic layer(s)

106 electrode

110 encapsulating cover

1. A flat-panel area illumination system, comprising:
a) a flat-panel lamp having a substrate and one or more non-pixellated light-emitting areas formed on the substrate emitting light in every direction from at least one light-emitting side of the lamp; and
b) a light-directing optical film located on the at least one light-emitting side over the light-emitting area of the flat-panel lamp, wherein the light-directing optical film preferentially directs light away from a direction perpendicular to the surface of the light-emitting side of the flat-panel lamp.

2. The flat-panel area illumination system claimed in claim 1, wherein the light-directing optical film includes a structured surface located adjacent to the light-emitting side of the flat-panel lamp.

3. The flat-panel area illumination system claimed in claim 2, wherein the light-directing optical film includes a flat surface located opposite to the light-emitting side of the flat-panel lamp.

4. The flat-panel area illumination system of claim 3, wherein a plurality of structures are associated with each light emitting area.

5. The flat-panel area illumination system claimed in claim 3, wherein the structured surface comprises triangular prisms.

6. The flat-panel area illumination system claimed in claim 3, wherein the structured surface comprises cylindrical lenses.

7. The flat-panel area illumination system claimed in claim 3, wherein the structured surface comprises a plurality of wedge-shaped structures having a long axis and in which the axes of the wedge-shaped structures are aligned in a common direction.

8. The flat-panel area illumination system claimed in claim 7, wherein the wedge-shaped structures are formed into parallel lines.

9. The flat-panel area illumination system claimed in claim 7, wherein the wedge-shaped structures are not formed into parallel lines.

10. The flat-panel area illumination system claimed in claim 7, wherein the wedge-shaped structures are formed in pairs of facing wedge-shaped structures.

11. The flat-panel area illumination system claimed in claim 1, wherein the light-directing optical film comprises a plastic or a glass.

12. The flat-panel area illumination system of claim 1, wherein the flat-panel lamp is an OLED lamp.

13. The flat-panel area illumination system of claim 1, further comprising a diffuser located between the light-directing optical film and the flat-panel lamp.

14. The flat-panel area illumination system of claim 1, further comprising a second light-directing optical film located over the light directing optical film and parallel to the light-directing optical film

15. The flat-panel area illumination system of claim 14, wherein light-directing structures of the second light-directing optical film are at a different angle to light-directing structures of the light-directing optical film.

16. The flat-panel area illumination system of claim 15, wherein the structures of the second light-directing optical film are at 90 degrees to the structures of the light-directing optical film.

17. The flat-panel area illumination system of claim 1, wherein the light-directing optical film is divided into a plurality of regions and light-directing structures in one region are oriented at a different angle from light-directing structures in a second region.

18. The flat-panel area illumination system of claim 17, wherein the structures within the regions alternate in orientation.

19. The flat-panel area illumination system of claim 17, wherein the structures within one region are oriented at 90 degrees with respect to the structures in another region.

20. The flat-panel area illumination system of claim 17, having at least four regions and wherein the structures within one region are oriented at multiples of 45 degrees with respect to the structures in another region.

21. The flat-panel area illumination system of claim 1, wherein the light-directing optical film is flexible.

22. The flat-panel area illumination system of claim 1, wherein the flat-panel lamp is flexible.

23. The flat-panel area illumination system of claim 1, wherein the light-emitting areas emit light in every direction from the light-emitting side in approximately the same amount.

24. The flat-panel area illumination system of claim 1, wherein the flat-panel lamp emits light from more than one side and a light-directing optical film is located over each light-emitting side.

25. The flat-panel area illumination system of claim 1, wherein the flat-panel lamp emits light through the substrate.

26. The flat-panel area illumination system of claim 1, wherein the flat-panel lamp further comprises an encapsulating cover located over the substrate and the light emitting area.

27. The flat-panel area illumination system of claim 26, wherein the emitted light is emitted through the cover.

28. The flat-panel area illumination system of claim 27, wherein the optical film is formed in the inside of the cover.

29. The flat-panel area illumination system of claim 27, wherein the optical film is located on the inside of the cover.

30. A method of making a flat-panel area illumination system, comprising the steps of:
a) providing a flat-panel lamp having a substrate with at least one non-pixellated light-emitting area formed on the substrate emitting light in every direction from at least one light-emitting side of the lamp;
b) providing a light-directing optical film that preferentially directs light away from a direction perpendicular to the surface of the light-emitting side of the flat-panel lamp; and
c) locating the optical film over the light-emitting area on the at least one light-emitting side of the flat-panel lamp.

31. The method claimed in claim 30, wherein the flat-panel lamp and the light-directing optical film are formed from a web in a continuous roll.

32. The method claimed in claim 31, wherein the light-directing optical film is formed by injection roll molding.
